(19) United States
(12) Patent Application Publication
(10) Pub. No.: US 2025/0320169 A1
(43) Pub. Date: Oct. 16, 2025

(54) POLYSULFIDE ENHANCED FERTILIZERS AND METHODS OF MAKING SAME

(71) Applicant: The Mosaic Company, Tampa, FL (US)

(72) Inventors: Michael McLaughlin, Montacute (AU); Jozefien Degryse, Parkside (AU); Roslyn Baird, Aberfoyle Park (AU); Ivan Andelkovic, Glenelg SA (AU)

(21) Appl. No.: 19/178,511

(22) Filed: Apr. 14, 2025

Related U.S. Application Data
(60) Provisional application No. 63/633,468, filed on Apr. 12, 2024.

(51) Int. Cl. C05F 11/00; C05G 5/12; C05G 5/30

(52) U.S. Cl. CPC C05F 11/00; C05G 5/12; C05G 5/30

(57) ABSTRACT

A polysulfide-enhanced fertilizer product and methods of making same. Polysulfides are manufactured by providing inputs of elemental sulfur, an energy source to heat the elemental sulfur to form sulfur radicals, and an organic chemical compound with the ability or functionality to react with heated elemental sulfur (radicals) and prevent them from returning to elemental sulfur when the mixture is cooled. The polysulfide can be incorporated as a coating on fertilizer granules or within the fertilizer granules. The polysulfide-enhanced granules can be with or without additional primary, secondary, and/or micro-nutrients, biostimulants, urease or nitrification inhibitors pesticides, herbicides, or other compounds providing enhanced efficiency characteristics into a granule.

### RELATED APPLICATIONS

This application claims the benefit of U.S. Provisional Application Ser. No. 63/633,468, filed Apr. 12, 2024, the disclosure of which is incorporated herein by reference in its entirety.

### TECHNICAL FIELD

The present application relates generally to fertilizers, and more specifically, to sulfur-fortified or sulfur-containing fertilizers.

### BACKGROUND

Fertilizers can be used to deliver nutrients to plants and the surrounding soil environments to grow healthier and stronger crops. Such nutrients can include primary nutrients like phosphorus, potassium, and nitrogen, secondary nutrients including sulfur, calcium, and magnesium, and micronutrients (trace) including boron, chlorine, copper, iron, manganese, molybdenum and zinc.

With respect to sulfur, sulfur can be present in elemental form, sulfate form, or both. While sulfate is a water-soluble form of sulfur, elemental sulfur is a water-insoluble form of sulfur. To be available for uptake by a plant, it must be first exposed to oxygen to oxidize into soluble sulfate form. Also, due to its insolubility in water, it is not readily leached through soil and lost to environmental waterways, thereby providing plants with a slow-release source of sulfur as it oxidizes to sulfate for plant uptake.

Elemental sulfur can be provided as a sulfur source to plants by being incorporated into fertilizer granules, such as phosphate fertilizers. However, due to chemical and physical quality constraints, in some instances this process can only accommodate a maximum of 15 wt % total sulfur or 7.5 wt % elemental sulfur in the granule while the targeted plants may require more.

In other applications, elemental sulfur can be incorporated into coatings for fertilizer granules. By using elemental sulfur in coatings, a higher amount of elemental sulfur can be achieved when compared to incorporating elemental sulfur into the granule, which can be advantageous to plants in some applications. Further, in some implementations, incorporating elemental sulfur into hydrophobic coatings can provide a slower release of sulfur to the plants than when the elemental sulfur is incorporated into the granule. However, elemental sulfur coatings have a propensity to produce elemental sulfur dust due to abrasion during transport and handling which creates an explosion risk. In some instances, this may be remedied by multiple coats of polymers, waxes, and other compounds to alleviate the dust risk. However, making and applying these additional coatings can be costly. In some applications, like broad acre farming systems, the additional cost can be untenable even though sulfur may be a needed nutrient.

Fertilizers can also be subject to harsh conditions. For example, during loading and transport, fertilizer abrasion amongst neighboring granules and equipment produce dust. Additionally, fertilizers can be stored in large quantities where humidity control is not always possible. As a result, the fertilizer can be subject to high and low humidity conditions, sometimes cycling between the two. Storage of fertilizers in high humidity conditions can lead to absorption of moisture. Furthermore, during storage, this moisture absorption, combined with the pressure created by the weight of the fertilizer, can lead to caking, further degradation of the fertilizer and dust. Such degradation can result in increased difficulty to distribute the fertilizer, decreased nutrient delivery efficiency, or total loss of use of the fertilizer.

### SUMMARY

The present disclosure generally relates to a manufacture and use of a polysulfide-enhanced fertilizer. Polysulfides are chemical compounds containing chains of sulfur atoms. For purposes of this application, the polysulfides as used herein refer to the organic class of polysulfides containing alternating chains of sulfur atoms and hydrocarbons. More specifically, polysulfide can be manufactured by providing inputs of elemental sulfur, an energy source to heat the elemental sulfur to form sulfur radicals, and an organic chemical compound with the ability or functionality to react with heated elemental sulfur (radicals) and prevent them from returning to elemental sulfur when the mixture is cooled.

In use, the polysulfide can be incorporated with or without additional primary, secondary, and/or micro-nutrients, biostimulants, urease or nitrification inhibitors pesticides, herbicides, or other compounds providing enhanced efficiency characteristics into a granule, such as a phosphorus- or phosphate-based fertilizer (e.g., monoammonium phosphate, diammonium phosphate, single superphosphate, triple superphosphate, struvite, etc.), potassium-based fertilizer (e.g., potassium chloride (KCl), muriate of potash (MOP), sulfate of potash, sulfate of potash-magnesia, potassium nitrate, potassium hydroxide, langbeinite (potassium magnesium sulfate), polyhalite (K₂Ca₂Mg(SO₄)₄·2H₂O), etc.), a nitrogen-based fertilizer (urea, nitrates or combinations thereof) or other macro-fertilizers such as, but not limited to, kieserite, or any combination thereof. Additionally, the produced polysulfide can be used with or without additional primary, secondary, and/or micro-nutrients and/or waxes or oils to provide a hydrophobic coating to fertilizer granules.

One exemplary benefit of the polysulfide enhanced fertilizer is that it can be manufactured at relatively low cost and does not have the same production restraints faced by elemental sulfur fertilizers. Additionally, the manufacturing process can be sustainable and utilize waste materials. Another exemplary benefit is that the polysulfide enhanced fertilizers can exhibit hydrophobic characteristics, thereby reducing moisture absorption in storage and allowing the fertilizer granules to better retain its physical attributes while efficiently delivering nutrients to plants and surrounding soil. Yet another exemplary benefit of the present disclosure is increased nutrient delivery to plants by mitigating unwanted sulfate leaching. Further, polysulfide is versatile in use, with the ability to be used either as a coating on fertilizer granules, and/or incorporated with other fertilizers to produce co-granules, compacted granules, or blends.

The summary above is not intended to describe each illustrated example or every implementation of the present disclosure. The figures and the detailed description that follow more particularly exemplify these examples.

### BRIEF DESCRIPTION OF THE DRAWINGS

The disclosure may be more completely understood in consideration of the following detailed description of examples of the disclosure in connection with the accompanying drawing, in which:

FIG. 1 shows a chart depicting water contact angles on polysulfide coated fertilizers comprised of 80% and 90% sulfur for polysulfides made from reaction times ranging from 30-300 minutes;

FIG. 2 shows a chart depicting weight gain of uncoated muriate of potash (MOP) fertilizer and polysulfide-coated MOP at relative humidities ranging from 60-80%; and

FIGS. 3A and 3B show caking tendencies of a potassium fertilizer exposed to high humidity storage conditions without a polysulfide coating (FIG. 3A) and with a 5% polysulfide coating (FIG. 3B).

While various examples are amenable to various modifications and alternative forms, specifics thereof have been shown by way of example in the drawings and will be described in detail. It should be understood, however, that the intention is not to limit the claimed inventions to the particular examples described. On the contrary, the intention is to cover all modifications, equivalents, and alternatives falling within the spirit and scope of the subject matter as defined by the claims.

### DETAILED DESCRIPTION

The following detailed description should be read with reference to the drawings in which similar elements in different drawings are numbered the same. The drawings, which are not necessarily to scale, depict illustrative examples and are not intended to limit the scope of the disclosure.

Manufacturing of polysulfide can be achieved in a low-cost process with three main inputs that facilitate the reaction to produce polysulfide. More specifically, this process can include (1) elemental sulfur, (2) an energy source, and (3) a chemical compound with the ability to react with the heated elemental sulfur (radicals) and prevent them from returning to elemental sulfur(S) when the mixture is cooled.

The energy source is one that is sufficient to break S—S bonds. In an exemplary embodiment, the energy source can be applied heat. Depending on the materials used in the reaction, the temperature required to facilitate the reaction can be or exceed 160 degrees Celsius. In some instances, if a catalyst is used, a lower temperature can be used to facilitate the reaction. In another exemplary embodiment, the energy source can be photons. In yet another exemplary embodiment, the energy source can be applied pressure.

Further, in an exemplary embodiment, the chemical compound can comprise a carbon source. The carbon source may be, for example, a waste material, canola oil, vegetable oil, peanut oil, soy oil, oleic acid, waxes, petroleum industry byproducts, or other reactive carbon molecules such as disulfides including tetra methyl thiuram disulfides (TMTD), 2,2′ Dithiobis (benzothiazole) (MBTS), zinc dibutyldithiocarbonate (ZBBC), zinc diethyldithiocarbonates (ZDEC) and similar sulfur radical forming carbon materials such as N-Tert-butyl-2-benzothiazoles sulfenamide (TBBS) and N-cyclohexyl-2-benzothiazole sulfenamide (CBS) and similar which can react with elemental sulfur. The reaction can be achieved at temperatures below 160 degrees Celsius by the addition of a catalyst and/or other compounds. In addition or alternatively to using catalysts, a lower reaction temperature can be achieved by allowing longer reaction times and/or by providing a secondary source of energy such as UV light, microwave, infrared, or by using mechanochemistry. In general, the reaction time for any of the previously described options will vary depending on batch size and temperature.

In some implementations, this manufacturing process may have a higher potential to meet elevated sustainability standards that may be applied to new fertilizer products. This can be achieved by incorporating waste streams into their manufacture. For example, byproducts from the petroleum industry or plant-based oils such as used cooking oils can have suitable carbon structures to facilitate the desired reaction. Additionally, the energy source used in the process can take the form of diverted heat from other areas of fertilizer manufacture, such as from a sulfuric acid plant or dryers.

In addition to these inputs, optional additives can be added to the reaction vessel as well. These additives can include other desired plant nutrients, biostimulants, biologicals, urease/nitrification inhibitors, pesticides, herbicides, paraffins or other waxes, and natural or synthetic processing aids to assist with the subsequent handling and application of the material. Optional additives can be included in the manufacturing process to assist with ease of application and/or flexibility, strength and longevity of subsequent coatings of the material.

The resulting material has improved versatility when applied to fertilizers. The polysulfide can be used as a coating on fertilizer granules and/or incorporated with other fertilizers to produce co-granules or blends. Even more flexibility comes from its ability to be formulated, depending on the raw materials, as a re-meltable material. This allows the polysulfide to be manufactured, solidified, stored, and remelted for ease of incorporation with fertilizers. For example, the same process that is used to add elemental sulfur into elemental sulfur-fortified macronutrient fertilizers can be used to apply this remolten material.

The produced compound contains sulfur in the form of polysulfide with concentrations of 0.1-99.9 wt % sulfur, and more particularly, 0.5-50 wt %, or 50 wt %-99.9 wt %, or any range therebetween. Any trace amounts of unreacted elemental sulfur remaining after the conversion are dispersed within the polysulfide matrix. This association with long carbon chains renders the sulfur safe to handle, reducing the potential for elemental sulfur particles abraded from granules with molten or particulate elemental sulfur. The stability and tenacity of the polysulfide manufactured as described herein result in the potential for higher incorporation or coating rates of sulfur. Incorporation and coating rates when using the described polysulfide can reach 90 wt %, a large improvement from the 15 wt % or less rate employed in some commercial products. Further, the sulfur incorporation and coating rate using the polysulfide described in this disclosure can reach 90 wt % when incorporated with other fertilizers.

The sulfur available to plants from both polysulfide and elemental sulfur sources relies on their oxidation by microbes in the soil resulting in conversion to sulfates. The polysulfide described shows a lower propensity for sulfur leaching than sulfate sources while achieving a similar plant availability as conventional elemental sulfur-based products. When the polysulfide is used as a fertilizer granule coating, the coating can still facilitate the ready release of nutrients from the granule while improving sulfur nutrient efficiency in the fertilizer by mitigating unwanted sulfur leaching. Examples of nutrients that can be released from the granule include nitrogen, phosphorus, potassium, or any combination thereof.

As previously mentioned, the agglomeration or hard caking of fertilizer granules can be a problem in storage, during transport, and on farms. This can result in irreversible product breakdown, dust generation, blockages and wear on farm equipment, and inconsistent fertilizer application. A large contributor to the caking problem is moisture uptake in the fertilizer due to humidity and temperature changes during storage and application. In some geographic regions this problem can be greater due to extreme humidity environments, for example, in regions where humidity can reach 90% where the fertilizer is transported, stored, and applied. Fertilizer granules having a hydrophobic coating can delay or even reduce caking by reducing moisture uptake.

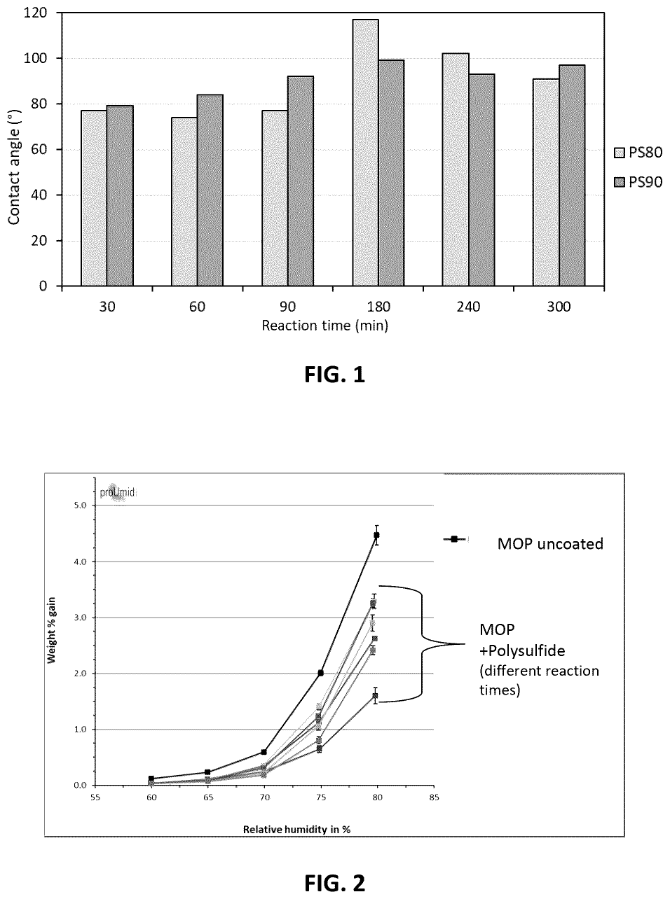

Applying the polysulfide coating to fertilizer granules can result in favorable physical properties that can reduce or prevent the caking problem. This is achieved because fertilizers coated with polysulfide have a higher hydrophobicity than uncoated fertilizers. Materials are commonly considered hydrophobic when contact angles between water droplets and the surface exceed 90°. In tests, polysulfide coatings comprising 80-90 wt % sulfur have been applied to glass slides. When exposed to water droplets, the resulting contact angles between the polysulfide coated slide and water have been measured between 90° and 117°, depending on the reaction time of the polysulfide. FIG. 1 illustrates the hydrophobic properties of the coating previously described by showing resulting contact angles for 80 wt % and 90 wt % sulfur coatings that underwent reaction times varying from 30 to 300 minutes. Additionally, the inherent surface roughness of fertilizers like MOP or KCl granules, when combined with the hydrophobic polysulfide coating, will likely drive the contact angle even higher. The increased hydrophobicity will be even more apparent when compared to the hydrophilic surface of uncoated MOP granules.

The hydrophobic properties of fertilizer granules coated with polysulfide reduce moisture uptake by the fertilizer when it is subjected to conditions of extremely high humidity. FIG. 2 illustrates this by showing reduced weight gain (indicating reduced moisture uptake) by polysulfide coated fertilizers when compared to uncoated fertilizers at relative humidities ranging from 60-80%. Reduced penetration of moisture into the granule results in the reduced likelihood for fertilizer nutrient solutions to form strong crystal bridges between granules when drying conditions return, which reduces the risk of caking or agglomeration. In some implementations, the polysulfide coatings can reduce moisture uptake when subjected to 80% relative humidity. In implementations where the polysulfide coating is produced with the shortest reaction time, the moisture uptake by a MOP fertilizer can be reduced by about 65%.

As mentioned previously, in addition to the polysulfide, additives beneficial for plant and soil health can be added to the fertilizer. For example, in some implementations, plants may require additional nutrients like micronutrients including copper, manganese, zinc, molybdenum, and boron (either alone or in combination) in trace amounts, or additional secondary nutrients like additional sulfur, calcium, and magnesium, or any variation or combination. To maximize nutrient efficiency, these nutrients can be distributed uniformly throughout the fertilizer. To achieve a uniform distribution, these nutrients can be incorporated into granular fertilizers either by co-granulation, compaction, and/or as a coating.

In an exemplary implementation, zinc can be incorporated into the polysulfide coating. Additionally, the coating has the potential to hold other micronutrients in its hydrophobic matrix. In the following example, zinc has been incorporated into the polysulfide coating in amounts up to 5 wt % or more, however, it is to be appreciated that different compositions can be similarly achieved, either with zinc or other nutrients.

TABLE 1
Formulations

| | | S | Zn | C. | Reaction | Reaction time |
|---|---|---|---|---|---|---|
| # | Formulation | (%) | (%) | (%) | temp. (° C.) | (min) |
| 1 | PS90_175_30 | 89 | 1.8 | 6.1 | 175 | 30 |
| 13 | PS80_175_30 | 80 | 3.4 | 11.2 | 175 | 30 |
| 25 | PS70_175_30 | 70 | 5.0 | 16.5 | 175 | 30 |

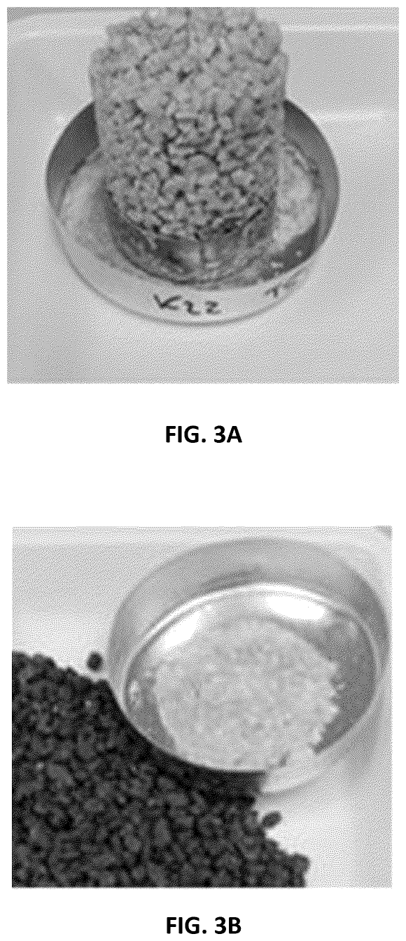

Tests can also demonstrate the increased handling benefits of polysulfide coated fertilizer, particularly with regard to the previously mentioned caking tendency. As previously discussed, the caking problem results from the formation of hard agglomerates, after fertilizers are exposed to high humidities and pressures in storage piles, for example. In an exemplary implementation, a potassium fertilizer (MOP) coated with 5 wt % polysulfide and 0.5 wt % zinc was compared with an uncoated MOP fertilizer. As seen in the table below, the coating resulted in reduced hardness of the caked sample, as illustrated by a reduction in force required to break apart the sample after being exposed to different pressure conditions. The handling benefits that result from the coating are also depicted in FIGS. 3A and 3B. As FIG. 3A shows, an uncoated MOP-KCl fertilizer “cakes” and sticks together even without applied pressure. Alternatively, as shown in FIG. 3B, a coated MOP-KCl avoids the caking and breaks apart when exposed to the same conditions.

TABLE 2
Force
Force to break cake after humidity (kgf)

| | No pressure (in test) | 8 kgf (in test) | 24 kgf (in test) |
|---|---|---|---|
| MOP | 2.5 | 17.3 | 126 |
| MOP + coating | No caking | 2.6 | 31 |

The disclosure may be embodied in other specific forms without departing from the essential attributes. Therefore, the illustrated examples should be considered illustrative and not restrictive in all respects. Any claims provided herein are to ensure adequacy of the present application for establishing foreign priority and for no other purpose.

Various examples of systems, devices, and methods have been described herein. These examples are given only be way of example and are not intended to limit the scope of the claimed disclosures. It should be appreciated, moreover, that the various features of the examples that have been described may be combined in various ways to produce numerous additional examples. Moreover, while various material, dimensions, shapes, configurations, locations, etc. have been described for use with disclosed examples, others besides those disclosed may be utilized without exceeding the scope of the claimed disclosures.

Persons of ordinary skill in the relevant arts will recognize that the subject matter hereof may comprise fewer features than illustrated in any individual example described above. The examples described herein are not meant to be an exhaustive presentation of the ways in which the various features of the subject matter hereof may be combined. Accordingly, the examples are not mutually exclusive combinations of features; rather, the various examples can comprise a combination of different individual features selected from different individual examples, as understood be persons of ordinary skill in the art. Moreover, elements described with respect to one example can be implemented in other examples even when not described in such examples unless otherwise noted.

Any incorporation of reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A sulfur-fortified fertilizer product comprising a plurality of fertilizer granules, each granule comprising:
a base fertilizer composition; and
a polysulfide additive containing elemental sulfur and a carbon source.

2. The fertilizer product of claim 1, wherein the polysulfide additive comprises a polysulfide coating.

3. The fertilizer product of claim 1, wherein the polysulfide additive is incorporated into the base fertilizer composition.

4. The fertilizer product of claim 1, wherein the polysulfide additive comprises sulfur in an amount of from about 1 wt % to about 99 wt % of the polysulfide additive.

5. The fertilizer product of claim 1, wherein the polysulfide additive comprises sulfur in an amount of from about 50 wt % to about 90 wt % of the polysulfide additive.

6. The fertilizer product of claim 1, wherein the carbon source is selected from the group consisting of a waste material, canola oil, vegetable oil, peanut oil, soy oil, oleic acid, waxes, petroleum industry byproducts, and combinations thereof.

7. The fertilizer product of claim 1, wherein the polysulfide additive is a disulfides.

8. The fertilizer product of claim 1, wherein the polysulfide additive is selected from the group consisting of tetra methyl thiuram disulfides (TMTD), 2,2′ Dithiobis (benzothiazole) (MBTS), zinc dibutyldithiocarbonate (ZBBC), zinc diethyldithiocarbonates (ZDEC), N-Tert-butyl-2-benzothiazoles sulfenamide (TBBS), N-cyclohexyl-2-benzothiazole sulfenamide (CBS), and combinations thereof.

9. The fertilizer product of claim 1, wherein the base fertilizer composition comprises a phosphate composition.

10. The fertilizer product of claim 9, wherein the phosphate composition comprises monoammonium phosphate, diammonium phosphate, single superphosphate, triple superphosphate, struvite, or combinations thereof.

11. The fertilizer product of claim 1, further comprising a micronutrient, secondary nutrient, or combinations thereof.

12. A method for producing a sulfur-fortified fertilizer product comprising a plurality of fertilizer granules, the method comprising:
providing a base fertilizer composition; and
heating elemental sulfur to a temperature sufficient to form sulfur radicals;
reacting with the sulfur radicals with an organic compound, thereby forming a polysulfide additive containing elemental sulfur and a carbon source; and
combining the polysulfide additive with the base fertilizer composition.

13. The method of claim 12, wherein the reacting step is carried out at a temperature of about 160 degrees Celsius or more.

14. The method of claim 12, wherein combining the polysulfide additive with the base fertilizer composition comprises co-granulating the polysulfide additive with the base fertilizer composition.

15. The method of claim 12, wherein the base fertilizer composition comprises a plurality of fertilizer particles, the polysulfide additive comprises a coating, and combining the polysulfide additive with the base fertilizer composition comprises coating the plurality of fertilizer particles.

16. The method of claim 15, wherein the coating is hydrophobic.

17. The method of claim 12, wherein the polysulfide additive comprises sulfur in an amount of from about 50 wt % to about 90 wt % of the polysulfide additive.

18. The method of claim 12, wherein the polysulfide additive is a disulfide.

19. The method of claim 12, wherein the carbon source is selected from the group consisting of a waste material, canola oil, vegetable oil, peanut oil, soy oil, oleic acid, waxes, petroleum industry byproducts, and combinations thereof.

20. The method of claim 12, wherein the base fertilizer composition is selected from the group consisting of phosphate, diammonium phosphate, single superphosphate, triple superphosphate, struvite, and combinations thereof.
